(19) United States
(12) Patent Application Publication
(10) Pub. No.: US 2022/0316800 A1
(43) Pub. Date: Oct. 6, 2022

(54) THERMAL TREATMENT OF MINERAL MATERIALS IN A REDUCING ATMOSPHERE USING ALTERNATIVE FUELS

(71) Applicants: thyssenkrupp Industrial Solutions AG, Essen (DE); thyssenkrupp AG, Essen (DE)

(72) Inventors: Jost LEMKE, Ennigerloh (DE); Ines VECKENSTEDT, Rietberg (DE); Guido GRUND, Werl (DE); Lutz KOSLOWSKI, Beckum (DE); Christian BRINKMANN, Bielefeld (DE)

(73) Assignees: thyssenkrupp Industrial Solutions AG, Essen (DE); thyssenkrupp AG, Essen (DE)

(21) Appl. No.: 17/632,139

(22) PCT Filed: Jul. 28, 2020
(86) PCT No.: PCT/EP2020/071201

§ 371 Date: Feb. 1, 2022

(30) Foreign Application Priority Data
Aug. 2, 2019 (BE) 2019/5505
Aug. 2, 2019 (DE) 10 2019 211 664.7

(51) Int. Cl. F27B 7/02; F27B 7/36; F27B 7/42; B01J 6/00

(52) U.S. Cl. CPC F27B 7/02; F27B 7/36; F27B 7/42; B01J 6/002; F27B 2007/025; F27D 2019/0012

(57) ABSTRACT

An apparatus for thermal treatment of mineral materials may include a first combustion chamber, a second combustion chamber, and a reactor for the thermal treatment of mineral materials. The first combustion chamber is configured for burning a first fuel fed by a first fuel feed device, and the first combustion chamber and the second combustion chamber are connected via a first conduit for transferring hot gases from the first combustion chamber into the second combustion chamber. The second combustion chamber is configured for burning a second fuel that is different than the first fuel and is fed by a second fuel feed device. The second combustion chamber and the reactor are connected via a second conduit for transferring hot gases from the second combustion chamber into the reactor. The reactor has a third feed conduit for introducing a third fuel.

The invention relates to a process for producing a clinker substitute and an apparatus for producing a clinker substitute.

Cement is an important raw material for the construction sector and the modern construction industry. The material is employed in very many different projects such as the construction of buildings or else in construction measures such as bridge and tunnel construction. Together with aggregates, for example sand, and water, cement hardens to form concrete. As water mortar, cement hardens even under water. “The most important lime-clay cement is “Portland cement”. It consists of 58-66% of CaO, 18-26% of SiO₂, 4-12% of Al₂O₃, 2-5% of Fe₂O₃ and contains mainly Ca₃SiO₄ (molar ratio about 2:1), additionally about 10% by weight of Ca₃Al₂O₆ and 1% by weight of Ca₂AlFeO₅”. (Holleman, Wiberg, Lehrbuch der Anorganischen Chemie, 102^{nd} edition, de Gruyter, 2007, p. 1257, ISBN: 978-3-11-017770-1, hereinafter Holleman, Wiberg).

As stated, for example, in DE 10 2004 038 313 A1, cement production can comprise the basic steps of preheating, calcination, clinker production in the firing furnace and cooling.

An important starting material in cement production is clay minerals. These clay minerals, for example limestone marl, are fired (about 1450° C.), in particular in finely milled form, in the further production process. After cooling, the sintered cement clinker can, for example, be milled with 2-5% of gypsum or anhydride and packed in sacks (Holleman, Wiberg, p. 1257).

Owing to the high firing temperature required, cement production is very energy-intensive. In order to keep the costs of cement production as low as possible, various, generally inexpensive, materials are burnt. These can be combustible gases, e.g. natural gas, combustible liquids (e.g. mineral oils) or combustible solids (e.g. coal dust). Residues obtained in other production processes are frequently also burnt.

The high energy consumption in classical cement clinker production combined with a continuing high demand for building materials incurs both high carbon dioxide emissions and nitrogen oxide emissions in cement production. Due to ever strict environmental regulations and laws and at the same time rising raw material and energy prices, the requirements which calcination and firing processes have to meet are increasing. This means that the formation of carbon dioxide and nitrogen oxides has to be reduced as far as possible when utilizing cheap and cost-effective fuels.

One possible way of reducing carbon dioxide consumption is the at least partial replacement of fossil fuels, for example and in particular by use of substitute fuels which can be obtained from waste materials, for example used tires, domestic waste or commercial waste, or else from biological materials. The burning of used tires can, for example, typically be carried out relatively safely in such plants because of the process parameters. Since these waste materials are in any case present, no additional fossil fuels are thus consumed for the energy required. However, it can be difficult to set a substoichiometric combustion in a targeted way because of the properties thereof (size or coarseness, moisture content, variable composition, high ignition temperature, . . . ).

A possible way of reducing carbon dioxide consumption, is the partial replacement of cement clinker by corresponding substitute materials, for example calcined clay. Examples thereof may be found in DE 10 2011 014 498 A1.

Efficient calcination processes in the field of cement production, in particular calcination, with optimization of carbon dioxide emission and thus an efficient and frugal combustion moreover frequently result in quite high formation of nitrogen oxides (NOₓ). Additional and technically quite complex additional steps or additional apparatuses are sometimes necessary in order to minimize nitrogen oxide formation.

DE 10 2004 038 313 A1 discloses a firing or calcination furnace for producing cement from furnace raw material.

DE 10 2014 113 127 A1 discloses a process and a plant for the thermal treatment of raw material which can be entrained in a string of gas. The raw material is introduced into a riser tube through which hot gases flow and is thermally treated there.

DE 10 2008 031 165 A1 discloses a method for operating a plant for producing calcined clay. According to that invention, the rotary tube furnace or roasting furnace is utilized as combustion chamber for producing hot gas, replaced by a combustion chamber and/or replaced by an additional combustion chamber.

DE 198 54 582 A1 discloses a process and a plant for the thermal treatment of meal-like raw materials.

U.S. Pat. No. 8,474,387 B2 discloses a plant and an apparatus for burning various combustible waste materials in cement production.

DE 10 2011 014 498 A1 discloses a clinker substitute and processes for producing the building materials based on the clinker substitute.

DE 10 2014 116 373 A1 discloses a process for the heat treatment of clays and/or zeolites under reducing conditions.

It is an object of the invention to provide a process for producing a clinker substitute, which process allows more efficient combustion of various fuels while minimizing the emission of pollutants, in particular of carbon dioxide and nitrogen oxides. It is likewise an object to be able to set the atmosphere of the thermal treatment in a targeted manner in order to generate a reducing atmosphere by substoichiometric combustion.

This object is achieved by an apparatus having the features indicated in claim 1 and by the process having the features indicated in claim 6. Advantageous embodiments may be derived from the dependent claims.

The apparatus of the invention for the thermal treatment of mineral materials comprises a first combustion chamber, a second combustion chamber and a reactor for the thermal treatment of mineral materials. The first combustion chamber is configured for burning a first fuel. The first combustion chamber and the second combustion chamber are connected via a first connection for transferring hot gases from the first combustion chamber into the second combustion chamber. The second combustion chamber is configured for burning a second fuel. The second combustion chamber and the reactor are connected via a second connection for transferring hot gases from the second combustion chamber into the reactor. The first combustion chamber has a first fuel feed device for introducing the first fuel. The second combustion chamber has a second fuel feed device for introducing the second fuel. The reactor has a third fuel feed conduit for introducing a third fuel. The first fuel and the second fuel are different.

An advantage of the apparatus of the invention is that the fuels can be different. In particular and preferably, the first fuel is selected from the group consisting of coal, coal dust, oil, natural gas, biogas, methane, ethane, propane, butane, hydrogen, and the second fuel is a substitute fuel. The first fuel in the first combustion chamber generates a sufficient temperature for even fuels which require an elevated temperature, for example biomass which has to be dried at the same time, to burn in the second combustion chamber. However, used tires, for example, cannot be so easily ignited.

Substitute fuels are fuels which are obtained from waste materials. These can be either solid, liquid or gaseous waste materials which are treated to a different degree of treatment. The waste materials used for producing substitute fuel can, for example, originate from households, industry or commercial businesses. The term substitute fuel encompasses all nonfossil fuels. They can be produced from selectively obtained, production-specific (commercial) waste materials and also from nonspecific waste material mixtures, for example domestic waste. For example, the treated secondary fuels obtained in a targeted manner from selected streams of material are used to a major extent in cement works because of the relatively high quality requirements of demanding processing technologies. With energy contents of about 15% and above, raw waste materials such as used tires, plastics, industrial and commercial waste materials and also animal meal and animal fats are suitable for producing substitute fuel for use in the cement industry. Used oil, solvents and domestic waste materials, inter alia, which have lower energy contents are utilized for treatment. Fractions of the secondary fuels which are capable of entrained flow are also referred to as “fluff” and are used in the cement industry.

The third fuel is, by way of example and in particular, selected from the group consisting of coal, coal dust, oil, natural gas, biogas, methane, ethane, propane, butane, hydrogen. The third fuel can then be metered comparatively readily in order to achieve substoichiometric combustion and burns easily and reliably in the reactor.

A fuel feed device is greatly dependent on the fuel used. In the case of solid fuel, it can be a conveyor belt or a screw, while in the case of liquid fuels it can be a nozzle and in the case of gaseous fuels can be a valve. A solid fuel, for example coal dust, can firstly be introduced into an airstream and thus be introduced in gaseous form through the fuel feed device.

In a further embodiment of the invention, the first combustion chamber has a first oxygen feed device and the second combustion chamber has a second oxygen feed device. The second combustion chamber, the second connection and/or the reactor has a sensor for measuring the oxygen content. The measurement of the oxygen content is particularly preferably used for regulating the amount of oxygen introduced via the oxygen feed devices.

A gas comprising oxygen is fed in via an oxygen feed device. This can be, for example, air, pure oxygen or else process gases depleted in oxygen, for example having an oxygen content of only 5% by volume. For this reason, the gas can also have a proportion of solids, for example ash or soot. The oxygen feed device can here be a purely passive opening in order to admit, for example, air from the surroundings. It can be a fan in order to transport the gas actively. Particularly when using process gases, the oxygen feed device can be a valve for regulating the inflow.

In a further embodiment of the invention, the second combustion chamber is configured for burning the second fuel on a grate. In particular, the solid second fuel, which is a substitute fuel, is conveyed over the grate or with the grate, in particular in order to discharge ash again at the side opposite the introduction of the second fuel. Optionally and preferably, oxygen can be introduced from below through the grate in order to burn the substitute fuel more efficiently.

In a further embodiment of the invention, the reactor is a rotary tube furnace or a calciner, in particular an entrained-flow calciner.

The apparatus can, for example, comprise an entrained-flow calciner. The entrained-flow calciner has a product inlet opening (for the product to be calcined) and a product outlet opening and a fuel gas opening. The product inlet opening is preferably arranged above, in the direction of flow of the fuel gas, the fuel gas opening. As a result of this arrangement, an entrainable (able to be entrained in the fuel gas stream) mineral mixture (e.g. clay minerals) can be conveyed by the fuel gas stream (calcination stream) through the entrained-flow calciner and is calcined within the entrained-flow calciner. The second combustion chamber is connected to the fuel gas opening and a combustion gas feed conduit (for example for air or air mixtures having a varying oxygen content) and a fuel feed conduit. The second combustion chamber further comprises, by way of example and preferably, a combustion on a grate. The combustion on a grate makes it possible to burn and utilize solid, liquid and also highly viscous fuels or combustible waste materials.

Furthermore, a product feed conduit is connected to the product inlet opening. In addition, an air feed conduit is provided and is connected via at least one valve to the entrained-flow calciner and/or the combustion chamber. The proportion of oxygen in the entrained-flow calciner can be regulated and controlled via the valve and the air feed conduit and pumps which are optionally connected.

The product feed conduit is preferably connected to one or more preheating device(s), preferably cyclone preheaters.

In a preferred embodiment of the invention, a sensor [lacuna]. The sensor/oxygen probe makes it possible to monitor the oxygen concentration in the entrained-flow calciner.

Furthermore, a device for data processing is preferably connected to the sensor and the valve.

The device for data processing which is connected to the sensor controls the additional gas stream, for example via controllable valves and pumps. The device for data processing preferably comprises a control device, e.g. a microprocessor with software and a signal transformer from the oxygen probe.

In a further aspect, the invention provides a process for the thermal treatment of mineral materials, wherein the process comprises the following steps:
a) combustion of a first fuel in a first combustion chamber,
b) transfer of the hot gases from the first combustion chamber into a second combustion chamber,
c) combustion of a second fuel in the second combustion chamber,
d) transfer of the hot gases from the second combustion chamber into a reactor,
e) substoichiometric combustion of a third fuel in the reactor and thermal treatment of mineral materials.

The process is particularly preferably carried out in an apparatus according to the invention.

The gases are particularly preferably heated in the first combustion chamber to a first temperature which is sufficient to ensure efficient combustion of the second fuel, namely the substitute fuel. The gases are heated further in the second combustion chamber in order to have a sufficient temperature to make the thermal treatment of the mineral materials possible in the reactor. Depending on the reactor used and the materials to be converted, this temperature is in the range from about 700° C. to 1500° C., and in the case of calcination of clinker in the reactor the temperature is, for example, in the range from 780° C. to 880° C., in the case of calcination of clinker substitutes is at temperatures of from 700° C. to 1100° C., in the case of sintering of clinker is, for example, in the range from 1350° C. to 1450° C.

This gradated process firstly makes it possible to use substitute fuels in the second combustion chamber and thus reduce the use of fossil raw materials in a targeted manner. Secondly, a reducing atmosphere can be created by substoichiometric combustion of the third fuel in the reactor in order to set product properties, for example color of the product, in an optimal way.

In a further embodiment of the invention, the introduction of the third fuel in order to achieve substoichiometric combustion is regulated on the basis of at least one of the measured parameters, where the parameter is selected from the group consisting of oxygen content in the second combustion chamber, oxygen content in the second connection, oxygen content in the reactor, properties, in particular color, of the product of the thermally treated mineral material after being taken from the reactor.

As an alternative or in addition, the introduction of oxygen into the reactor can be regulated on the basis of the measured parameter.

In a further embodiment of the invention, the thermal treatment is carried out at an oxygen partial pressure pO₂ of less than 10⁻⁸ bar, preferably pO₂ less than 10⁻¹¹ bar.

In a further embodiment of the invention, the thermal treatment is carried out at a volume ratio of CO₂/CO of less than 1000, preferably less than 50.

In a further embodiment of the invention, the thermal treatment is carried out at an air index (λ[lambda]) of less than 1, preferably λ[lambda]=0.70 to 0.99, particularly preferably λ[lambda]=0.85 to 0.98. The air index or lambda value or the combustion air ratio is defined as the ratio of the amount of air fed in to the amount of air for stoichiometric combustion (see also RÖmpp, Chemie Lexikon, 9th edition, 1995, page 2437, “Lambda-Wert”).

Further steps for the thermal treatment are, by way of example and in particular, provision of a mineral, clay-containing mixture. The mineral, clay-containing mixture preferably contains at least 5% by weight of clays, aluminas, sheet silicates, for example clay minerals, preferably, for example, kaolin or kaolin mixtures. In combustion on a grate, where the combustion on a grate is arranged in the second combustion chamber, a hot gas stream, for example a calcination stream, is provided. For the purposes of the invention, the expression “calcination stream” describes the gas stream which consists of combustion gases and is formed in the combustion chamber by combustion of fuel in the combustion on a grate. The combustion on a grate also allows the combustion of solid, liquid and highly viscous fuels. The combustion on a grate provides the calcination stream and thus the gas stream for calcination. The mineral, clay-containing mixture is calcined in the calcination stream under substoichiometric conditions in respect of the oxygen content and a calcined mixture is subsequently obtained. For the purposes of the invention, the expression “substoichiometric conditions in respect of the oxygen content” preferably encompasses, firstly, calcination conditions having an oxygen content which is not sufficient to allow complete oxidation of the clay minerals and, secondly, a calcination under reducing conditions. For the purposes of the invention both reaction conditions can be present side by side. The calcination preferably does not encompass any separate oxidation reaction under a superstoichiometric excess of oxygen. The “substoichiometric conditions in respect of the oxygen content” preferably involve an air index (lambda) of less than 1. The calcined mineral mixture obtained can replace part of the clinker in the cement. Owing to the process conditions employed according to the invention, the color of the product can be altered and the emission of nitrogen oxides can be reduced.

The mineral, clay-containing mixture preferably comprises sheet silicates, clays, feldspars, preferably kaolin, metakaolinite, illite, Al—Si spinels, montmorillonite, mullite, schamotte, bentonite, smectite, chrysotile, chlorite and/or vermiculite and/or mixtures thereof.

In a preferred embodiment, the mineral mixture (1) contains from 0.1% by weight to 4% by weight of carbon. Surprisingly, the above-described carbon contents allow advantageous reduction of the iron present in the mineral mixture. Here, the (red) hematite (Fe₂O₃) is converted into gray magnetite (Fe₃O₄). Magnetite gives the clinker substitute a gray color.

In a further preferred embodiment of the invention, the calcination is carried out at a temperature of from 800° C. to 1100° C. in the calcination stream.

The calcination is preferably carried out in an entrained-flow calciner.

In a preferred embodiment of the process, the entrained-flow calciner is connected via a valve to an additional gas stream in a regulatable manner. The oxygen content and the flow velocity can be adapted individually via the valve.

The additional gas stream preferably has an oxygen content of from 5% by volume to 15% by volume, preferably from 7% by volume to 12% by volume.

Furthermore, the additional gas stream preferably comprises recirculated air, preferably air recirculated from a filter plant.

In a preferred embodiment, the additional gas stream is regulated as a function of the oxygen content in the entrained-flow calciner. The oxygen content is particularly preferably measured by an oxygen probe in the entrained-flow calciner. For the purposes of the invention, the expression “oxygen probe” preferably encompasses lambda probes and/or doped ZrO₂ probes. The O₂ partial pressure can preferably be determined via the Nernst equation. The additional gas stream is controlled via a device for data processing which is connected to the oxygen probe, for example via controllable valves and pumps.

The mineral mixture is preferably preheated in a cyclone preheater.

In a preferred embodiment, the calcination is carried out without an additional step with a stoichiometric or superstoichiometric proportion of oxygen. The avoidance of these steps reduces the emission of nitrogen oxides.

The mineral mixture is preferably preheated before the calcination, particularly preferably preheated in the cyclone preheater.

In a preferred embodiment, the calcination is carried out in cocurrent.

The invention will be illustrated below with the aid of an example. The example does not restrict the invention.

In a simulation, the carbon dioxide emission in the production of one metric ton of Portland cement clinker and the production of one metric ton of calcined clay, preferably kaolin, by the process of the invention were compared.

TABLE 1

| | Temperature [° C.] | Carbon dioxide formation [kg] |
|---|---|---|
| Portland cement clinker | 1450 | 830 |
| Calcined clay | 800 | 200 |
| Composite cement | — | 640 |
| (30% calcined clay) | | |

It can be seen from Table 1 that the production of calcined kaolin by the process of the invention decreases carbon dioxide formation by a factor of about 4. In addition, at 800° C. instead of 1450° C., the operating temperature required is significantly lower and the energy consumption is thus significantly less. Significant decreases are also found in the case of the composite cement.

The invention will be illustrated below with the aid of the figure. The figure does not restrict the invention. The figure is not true to scale.

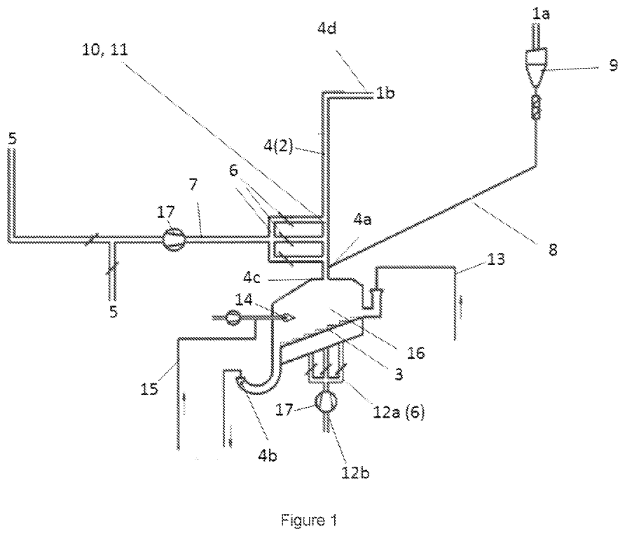

FIG. 1 shows a schematic view of the apparatus of the invention. The apparatus comprises at least the following elements. An entrained flow calciner 4 comprises a product inlet opening 4a, a product outlet opening 4d for discharge of the calcined mixture 1b produced and a fuel gas opening 4c. The product inlet opening 4a is preferably arranged above the fuel gas opening 4c in the flow direction of the fuel gas. As a result of this arrangement, a suspendable mineral mixture 1a (e.g. clay minerals) which can be entrained in the fuel gas stream can be conveyed, after preheating in preheating stages, e.g. cyclone preheaters 9, by the fuel gas stream or calcination stream 2 through the entrained-flow calciner 4 and is calcined within the entrained-flow calciner 4. A combustion chamber 16 is connected to the fuel gas opening 12a and a combustion gas feed conduit 12b (for example for air or air mixtures having a varying oxygen content) and a fuel feed conduit 13. Valves 6 make it possible to regulate the combustion gas feed conduit 12b. The combustion chamber 16 further comprises a combustion on a grate 3. The combustion on a grate 3 makes it possible for solid, liquid or highly viscous fuels or combustible waste materials to be burnt and utilized. A residue opening 4b makes it possible to remove the fuel residues which do not burn. The fuel present in the combustion chamber 16 is ignited by an ignition burner 14 with fuel introduction conduit 15. Furthermore, a product feed conduit 8 is connected to the product inlet opening 4a. In addition, an air feed conduit 7 for an additional gas stream 5 is provided, with the air feed conduit 7 being connected via at least one valve 6 to the entrained-flow calciner 4 and/or the combustion on a grate. The proportion of oxygen in the entrained flow calciner 4 can be regulated and controlled via the valve 6 and the air feed conduit 7 and optionally connected blowers 17. An oxygen probe 10 and a device for data processing 11 (not shown) are optionally also present.

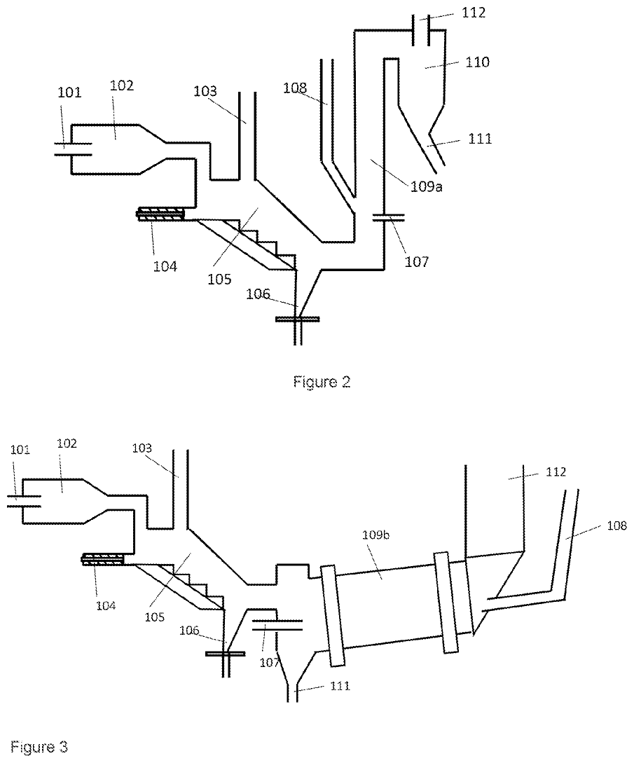

Two further apparatuses according to the invention are depicted in FIG. 2 and FIG. 3. FIG. 2 shows an embodiment with an entrained-flow calciner 109a and FIG. 3 shows an embodiment with a rotary tube furnace 109b.

In both embodiments, a first fuel, for example coal dust fluidized in air, is initially introduced via a first fuel feed device 101 into the first combustion chamber 102 and burnt there. The hot gases which arise are conveyed via a first connection into the second combustion chamber 105. There, the substitute fuel is fed via a second fuel feed device 104, for example a screw, to the second combustion chamber 105 and burnt on a grate, which here has a step-like configuration. In this way, the ash from the second fuel is conveyed to the ash discharge 106 and discharged. In order to improve the combustion of the second fuel in the second combustion chamber 105, the second combustion chamber 105 has a second oxygen feed device 103. The hot gases from the second combustion chamber 105 are conveyed via a second connection into the reactor 109a, 109b.

In the first embodiment of FIG. 2, the reactor is an entrained-flow calciner 109a. The entrained-flow calciner 109a has a third fuel feed device 107 and a starting material feed conduit 108. The process is regulated so that the third fuel is converted in a substoichiometric combustion in the entrained-flow calciner 109a and a reducing atmosphere is thus generated. Downstream of the entrained-flow calciner 109, the product is separated off in a cyclone 110 and taken off through the product discharge conduit 111, while the hot gases are fed through the offgas conduit 112 to, for example, a preheater. In this embodiment, starting material and hot gases are conveyed in cocurrent.

In the second embodiment shown in FIG. 3, the reactor is a rotary tube furnace 109b. In this embodiment, starting material and hot gases are conveyed in countercurrent, which constitutes a significant difference from the first embodiment of FIG. 2. The starting material feed conduit 108 is arranged at the end of the rotary tube furnace 109b opposite the second connection. At this end, there is also the offgas conduit 112 through which the hot gases can be conveyed into a calciner and/or a preheater. The third fuel feed device 107 is arranged next to the third connection and thus at the same end of the rotary tube furnace 109b as the product discharge conduit 111.

### LIST OF REFERENCE NUMERALS

1a Mineral mixture
1b Calcined mixture
2 Calcination stream
3 Combustion on a grate
4 Entrained-flow calciner
4a Product inlet opening
4b Residue opening
4c Fuel gas opening
4d Product outlet opening
5 Additional gas stream
6 Valve
7 Air introduction conduit
8 Product feed conduit
9 Preheating stages
10 Oxygen probe
11 Device for data processing
12a Fuel gas opening
12b Combustion gas feed conduit
13 Fuel feed conduit
14 Ignition burner
15 Fuel introduction conduit
16 Combustion chamber
17 Blower
101 First fuel feed device
102 First combustion chamber
103 Second oxygen feed device
104 Second fuel feed device
105 Second combustion chamber
106 Ash discharge
107 Third fuel feed device
108 Starting material feed conduit
109a Entrained-flow calciner
109b Rotary tube furnace
110 Cyclone
111 Product discharge conduit
112 Offgas conduit

1.-10. (canceled)

11. An apparatus for thermal treatment of mineral materials, the apparatus comprising:
a first combustion chamber configured to burn a first fuel, with the first combustion chamber comprising a first fuel feed device for introducing the first fuel;
a second combustion chamber configured to burn a second fuel that is different than the first fuel, the second combustion chamber being connected to the first combustion chamber via a first conduit for transferring hot gasses from the first combustion chamber into the second combustion chamber, wherein the second combustion chamber comprises a second fuel feed device for introducing the second fuel; and
a reactor for thermal treatment of mineral materials, wherein the second combustion chamber and the reactor are connected via a second conduit for transferring hot gases from the second combustion chamber into the reactor, wherein the reactor has a third fuel feed conduit for introducing a third fuel.

12. The apparatus of claim 11 wherein the first fuel is coal, coal dust, oil, natural gas, biogas, methane, ethane, propane, butane, or hydrogen, wherein the second fuel is a substitute fuel.

13. The apparatus of claim 11 wherein the first combustion chamber includes a first oxygen feed device, wherein the second combustion chamber includes a second oxygen feed device, wherein at least one of the second combustion chamber, the second conduit, or the reactor includes a sensor for measuring oxygen content.

14. The apparatus of claim 11 wherein the second combustion chamber is configured to burn the second fuel on a grate.

15. The apparatus of claim 11 wherein the reactor is a calciner.

16. The apparatus of claim 11 wherein the reactor is an entrained-flow calciner.

17. The apparatus of claim 11 wherein the reactor is a rotary tube furnace.

18. A process for thermally treating mineral materials, the process comprising:
combusting a first fuel in a first combustion chamber;
transferring hot gasses from the first combustion chamber into a second combustion chamber;
combusting a second fuel in the second combustion chamber;
transferring hot gasses from the second combustion chamber into a reactor; and
substoichiometrically combusting a third fuel in the reactor and thermally treating mineral materials.

19. The process of claim 18 comprising regulating introduction of the third fuel for substoichiometric combustion based on a color of the thermally treated mineral materials after removal from the reactor.

20. The process of claim 18 comprising regulating introduction of the third fuel for substoichiometric combustion based on a measured parameter, wherein the measured parameter is oxygen content in the second combustion chamber, oxygen content in a connection between the second combustion chamber and the reactor, oxygen content in the reactor, or a property of a product of the thermally treated mineral materials after removal from the reactor.

21. The process of claim 18 wherein thermally treating the mineral materials is performed at an oxygen partial pressure pO₂ of less than 10⁻⁸ bar.

22. The process of claim 18 wherein thermally treating the mineral materials is performed at an oxygen partial pressure pO₂ of less than 10⁻¹¹ bar.

23. The process of claim 18 wherein thermally treating the mineral materials is performed at a volume ratio of CO₂/CO of less than 1000.

24. The process of claim 18 wherein thermally treating the mineral materials is performed at a volume ratio of CO₂/CO of less than 50.

25. The process of claim 18 wherein thermally treating the mineral materials is performed at an air index of less than 1.

26. The process of claim 18 wherein thermally treating the mineral materials is performed at an air index of between 0.70 and 0.99.

27. The process of claim 18 wherein thermally treating the mineral materials is performed at an air index of between 0.85 and 0.98.
